(19) United States
(12) Patent Application Publication
(10) Pub. No.: US 2020/0402510 A1
(43) Pub. Date: Dec. 24, 2020

(54) CALENDAR-BASED INFORMATION MANAGEMENT SYSTEM

(71) Applicant: Carrie D. Sluiter, Kalamazoo, MI (US)

(72) Inventor: Carrie D. Sluiter, Kalamazoo, MI (US)

(21) Appl. No.: 17/014,664

(22) Filed: Sep. 8, 2020

Related U.S. Application Data
(63) Continuation-in-part of application No. 29/682,332, filed on Mar. 4, 2019, now Pat. No. D896889.

(51) Int. Cl. G10L 15/22; G06F 3/16; G06F 3/0488; G06F 3/0482

(52) U.S. Cl. CPC G10L 15/22; G06F 3/167; G10L 2015/223; G06F 3/0482; G06F 3/0488

(57) ABSTRACT

Disclosed herein is a calendar-based information management system. The system may include a touchscreen display for displaying digital content and receiving a touch input, a speaker to produce an audible output, a communication device to communicate with an external electronic device, a GUI engine for generating the GUI presented through the touchscreen, a user management engine to manage a plurality of user profiles, a speech recognition engine to perform speech recognition, a command processing engine to process at least one command, a storage device to retrievably store a plurality of calendar event data and at least one digital data, a category management engine to management a plurality of categories associated with the plurality of calendar event data, a notification engine to generate at least one notification based on the plurality of calendar event data and a document and image repository engine to process at least one digital document.

### FIELD OF THE INVENTION

Generally, the present disclosure relates to a field of data processing. More specifically, the present disclosure relates to calendar-based information management systems.

### BACKGROUND OF THE INVENTION

All across the globe, people have long used the calendar to organize their social, commercial or administrative activities. For example, people use the calendar for appointments, schedules, important events and dates to remember. Traditional calendars are made of paper, and people can handwrite event entries onto the calendar as personal reminders and daily schedules to follow. Digital calendars have been developed to replace the traditional calendars. Digital calendars are more convenient to use and easier to maintain, as people can interact with the calendar and readily edit the entries. In today's world, almost everyone owns at least one calendar on his laptop, on his cell phone, or on even on his car. A user can synchronize his calendars across different devices to make sure that the calendar on each device is kept up to date.

However, for members in a particular group, e.g. in a family or in a company, they are unable to maintain their calendars in a single place, with documents, receipts, and other important files. This leads to scheduling conflicts and inefficiency. There is a major need for a life-organizer and document management calendar. For example, if family members wish to create a pediatrician appointment, they usually need to set separate appointment reminders in their own calendars. Moreover, groups can coordinate time of the appointment even modify their appointment reminders respectively, which could otherwise be burdensome. Upon leaving the appointment a simple command will copy, store, and file a document e.g shot record or test results. When you need the information, it is one touch or command away.

As many families are overwhelmed by the demands of daily life. Further, apps, remotes, and devices organize and run everything in businesses and homes with the touch of a button, everything except for life-management. Further, nothing currently exists in technology to specifically target the struggling family's need for long-term life-management and organization. Also, everything families need from important documents to digital photos are still scattered amidst apps, devices, and paper. In this area of people's lives, everything still sends them on a stressful search.

Therefore, there is a need for improved calendar-based information management systems that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a calendar-based information management system. The system may include a touchscreen display configured for displaying digital content and receiving a touch input corresponding to the digital content. Further, the system may include a speaker configured to produce an audible output. Further, the system may include a communication device configured to communicate with an external electronic device over a wireless communication channel. Further, the system may include a graphical user interface (GUI) engine configured for generating the GUI presented through the touchscreen. Further, the system may include a user management engine configured to manage a plurality of user profiles associated with the calendar-based information management system. Further, the system may include a speech recognition engine configured to perform speech recognition of a speech input and determine at least one command. Further, the system may include a command processing engine configured to process the at least one command based on at least one of the speech input and the touch input. Further, the system may include a storage device configured to retrievably store a plurality of calendar event data and at least one digital data, wherein the storing is based on the at least one command. Further, the system may include a category management engine configured to management a plurality of categories associated with the plurality of calendar event data. Further, the system may include a notification engine configured to generate at least one notification based on the plurality of calendar event data. Further, the system may include a document and image repository engine configured to process at least one digital document.

According to some embodiments, a calendar-based information management system is disclosed. The calendar-based information management system may include a touchscreen display configured for displaying digital content and receiving a touch input corresponding to the digital content. Further, the calendar-based information management system may include a speaker configured to produce an audible output. Further, the calendar-based information management system may include a communication device configured to communicate with an external electronic device over a wireless communication channel. Further, the calendar-based information management system may include a graphical user interface (GUI) engine configured for generating the GUI presented through the touchscreen. Further, the calendar-based information management system may include a user management engine configured to manage a plurality of user profiles associated with the calendar-based information management system. Further, the calendar-based information management system may include a speech recognition engine configured to perform speech recognition of a speech input and determine at least one command. Further, the calendar-based information management system may include a command processing engine configured to process the at least one command based on at least one of the speech input and the touch input. Further, the calendar-based information management system may include a storage device configured to retrievably store a plurality of calendar event data and at least one digital data, wherein the storing is based on the at least one command. Further, the calendar-based information management system may include a category management engine configured to management a plurality of categories associated with the plurality of calendar event data. Further, the calendar-based information management system may include a notification engine configured to generate at least one notification based on the plurality of calendar event data. Further, the calendar-based information management system may include a document and image repository engine configured to process at least one digital document. Further, the calendar-based information management system may include at least one fastener configured to mount the calendar-based information system on a wall. Further, the calendar-based information management system may include a kickstand configured to maintain the calendar-based information management system in a standing position on a horizontal surface.

According to some embodiments, a calendar-based information management system is disclosed. The calendar-based information management system may include a touchscreen display configured for displaying digital content and receiving a touch input corresponding to the digital content. Further, the calendar-based information management system may include a speaker configured to produce an audible output. Further, the calendar-based information management system may include a communication device configured to communicate with an external electronic device over a wireless communication channel. Further, the calendar-based information management system may include a graphical user interface (GUI) engine configured for generating the GUI presented through the touchscreen. Further, the calendar-based information management system may include a user management engine configured to manage a plurality of user profiles associated with the calendar-based information management system. Further, the calendar-based information management system may include a speech recognition engine configured to perform speech recognition of a speech input and determine at least one command. Further, the calendar-based information management system may include a command processing engine configured to process the at least one command based on at least one of the speech input and the touch input. Further, the calendar-based information management system may include a storage device configured to retrievably store a plurality of calendar event data and at least one digital data, wherein the storing is based on the at least one command. Further, the calendar-based information management system may include a category management engine configured to management a plurality of categories associated with the plurality of calendar event data. Further, the calendar-based information management system may include a notification engine configured to generate at least one notification based on the plurality of calendar event data. Further, the calendar-based information management system may include a document and image repository engine configured to process at least one digital document. Further, the calendar-based information management system may include at least one fastener configured to mount the calendar-based information system on a wall. Further, the calendar-based information management system may include a kickstand configured to maintain the calendar-based information management system in a standing position on a horizontal surface. Further, the calendar-based information management system may include a document scanner configured to generate a digital document corresponding to a physical document. Further, the document and image repository engine is configured to store the digital document. Further, the document scanner may include a digital imaging/camera.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

FIG. 1 is an illustration of an online platform consistent with various embodiments of the present disclosure.

FIG. 2 is a block diagram of a calendar-based information management system, in accordance with some embodiments.

FIG. 3 is a block diagram of the calendar-based information management system, in accordance with some embodiments.

FIG. 4 is a block diagram of the calendar-based information management system, in accordance with some embodiments.

FIG. 5 is a block diagram of the calendar-based information management system, in accordance with some embodiments.

FIG. 6 is a block diagram of the calendar-based information management system, in accordance with some embodiments.

FIG. 7 is a block diagram of the calendar-based information management system, in accordance with some embodiments.

FIG. 8 is a block diagram of the calendar-based information management system, in accordance with some embodiments.

FIG. 9 is a block diagram of a calendar-based information management system, in accordance with some embodiments.

FIG. 10 is a block diagram of a calendar-based information management system, in accordance with some embodiments.

FIG. 11 is an illustration of architecture for implementing the present disclosure, in accordance with some embodiments.

FIG. 12 illustrates the flow of data between the components of the calendar-based information management system, in accordance with some embodiments.

FIG. 13 is a flowchart of a method to process the commands, in accordance with some embodiments.

FIG. 14 is a flowchart of a method to generate notifications, in accordance with some embodiments.

FIG. 15 is a digital wall mountable device, in accordance with some embodiments.

FIG. 16 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of calendar-based information management systems, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice-based interface, gesture-based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third-party database, a public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role-based access control, and so on.

Further, one or more steps of the method disclosed herein may be initiated, maintained, controlled and/or terminated based on a control input received from one or more devices operated by one or more users such as, for example, but not limited to, an end-user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human-readable secret data (e.g. username, password, passphrase, PIN, secret question, secret answer, etc.) and/or possession of a machine-readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human-readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor, etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device

### Overview

The present disclosure relates generally to an information management system, and more particularly to a calendar-based information management system. Users of the present disclosure may be able to store their respective calendar events in a single device, categorize the events for easy access according to personal preference, and retrieve the events and other information in a more convenient way.

Further, the disclosed calendar-based information management system may allow a plurality of users to manage their personal or business activities, share documents and images, and remotely control the system from their personal digital devices.

According to some embodiments, an information management system which may operate on a digital calendar or other electronic devices to organize information for a particular group of people is disclosed. The information of each user in the group may be categorized by user-defined subject types and retrieved by user identities or categories. The information management system may also able to store and share documents and images. The present disclosure further offers additional functions including but not limited to touch or voice control, photo scrapbooks, alarm reminder, etc.

Further, the present disclosure describes a smart talk calendar & life organizer. Further, the most important, unique, original purpose and features of the smart talk calendar & life organizer may include combining the calendar feature needs with the life organizer and document storage to master and modernize life management particularly for families. Further, the smart talk calendar & life organizer may acknowledge real problems. As many families are overwhelmed by the demands of daily life. Apps, remotes, and devices organize and run everything in businesses and homes with the touch of a button, everything except for life-management. Family is the most valuable possession for an individual. Further, the life of the individual is the most important business that the individual runs. Further, the smart talk calendar & life organizer specifically target the struggling family's need for long-term life-management and organization. Further, the smart talk calendar & life organizer may provide everything families need from important documents to digital photos. Further, Smart Talk Calendar Life Organizer (smart talk calendar & life organizer) may organize the everyday life of the individual with remote control access. Further, the Smart Talk Calendar Life Organizer is not just another “digital calendar.” Further, the Smart Talk Calendar Life Organizer brings the paper wall calendar into the digital age. The Smart Talk Calendar Life Organizer is specifically designed to target the many growing needs of today's digital world families. Like Google™, Alexa™, and Siri™ may provide information for worldly things, the Smart Talk Calendar Life Organizer may give the individual access to the individual's personal information and documents, i.e insurance certificates, school records, shot records to copies of the bills and receipts, even tally's, totals and balances. Further, the individual may take a photo or scan any item and say “MyTekc” save to a name. Further, the Smart Talk Calendar Life Organizer may file and store the image. Further, the individual may ask MyTekc for the file to retrieve it view it, or print it or email it. Further, the Smart Talk Calendar Life Organizer may give a total of tally in seconds for individual categories determined and set by the owner. The Smart Talk Calendar Life Organizer may be designed to be any family's personal assistant. The Smart Talk Calendar Life Organizer organizes everything from will's to phone bills to family member schedules. The Smart Talk Calendar Life Organizer may be a file cabinet/in a digital storage device that keeps important doc's, dates, and digital photos safe and may make the important doc's, the dates, and the digital photos easily transferable and generational. The Smart Talk Calendar Life Organizer may be used by families working with Foster Care or Social Workers As a Social Worker, the MyTekc calendar may help with scanning, storing, and retrieving information for clients. It may allow social workers to go into client meetings with one device versus having to bring a piece of luggage with several devices. Further, the families may always be prepared with anything the workers require at a touch or ask or command.

The Smart Talk Calendar Life Organizer may be used by the entrepreneurial families to keep the entrepreneurial families more organized and prepared when the tax season arrives. Further, for everyday life and living the scanning feature may assist in keeping the household's paperwork, pictures, and calendars up to date and easily accessible.

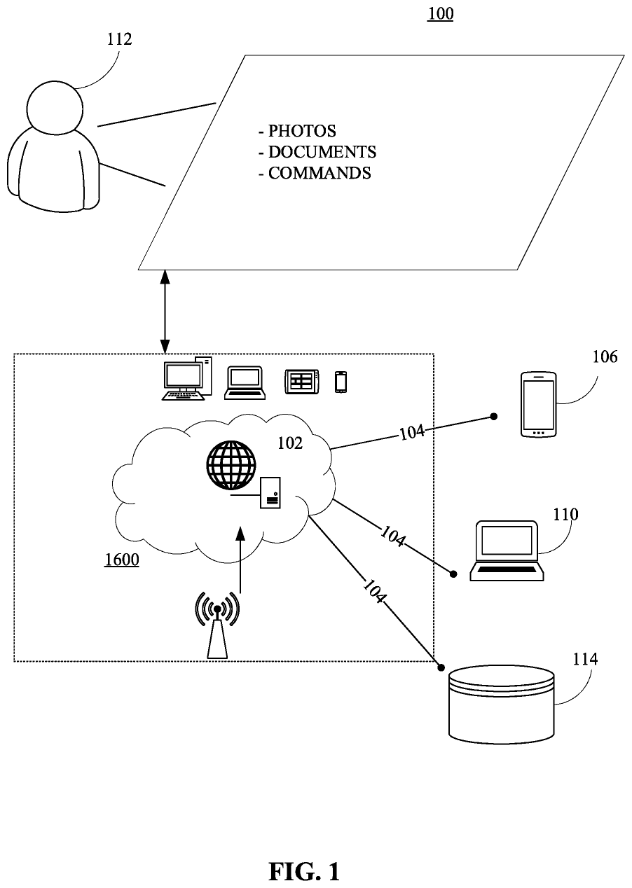

FIG. 1 is an illustration of an online platform 100 consistent with various embodiments of the present disclosure. By way of non-limiting example, the online platform 100 to facilitate the calendar-based information management system may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform 100.

A user 112, such as the one or more relevant parties, may access online platform 100 through a web-based software application or browser. The web-based software application may be embodied as, for example, but not be limited to, a website, a web application, a desktop application, and a mobile application compatible with a computing device 1600.

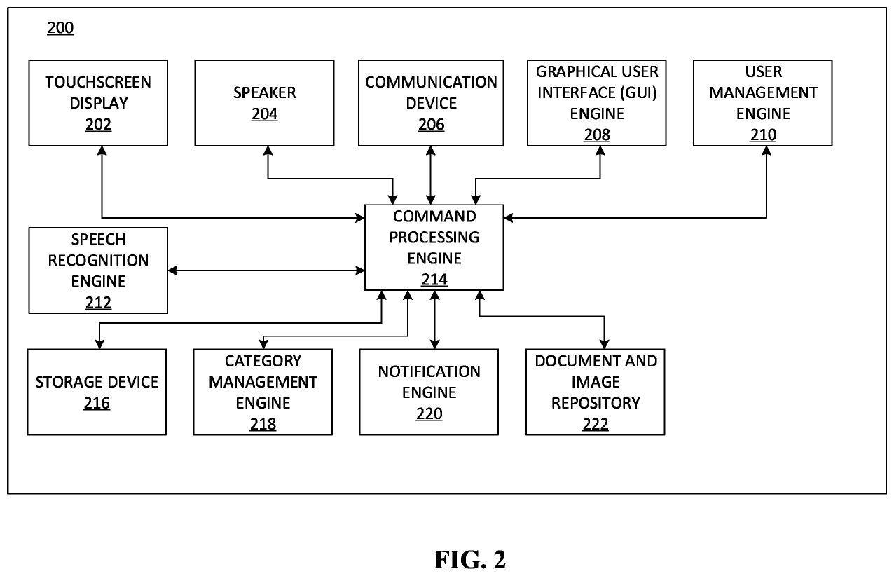

FIG. 2 is a block diagram of a calendar-based information management system 200, in accordance with some embodiments. The calendar-based information management system 200 may include a touchscreen display 202 configured for displaying digital content and receiving a touch input corresponding to the digital content.

Further, the calendar-based information management system 200 may include a speaker 204 configured to produce an audible output.

Further, the calendar-based information management system 200 may include a communication device 206 configured to communicate with an external electronic device over a wireless communication channel.

In further embodiments, the communication device 206 may be configured to receive the speech input from the external electronic device. Further, the external electronic device may include a microphone configured to convert an acoustic input into a speech input.

In some embodiments, the touch input may include a first touch input and a second touch input. Further, the first touch input may be associated with a day of a calendar displayed on the touchscreen. Further, the second touch input may be associated with a category of the plurality of categories. Further, the speech input may include a description. Further, the at least one calendar event data may be based on each of the first input, the second input and the description.

Further, the calendar-based information management system 200 may include a graphical user interface (GUI) engine 208 configured for generating the GUI presented through the touchscreen.

In further embodiments, the GUI engine 208 may be associated with an active mode and an idle mode. Further, in the idle mode, the GUI engine 208 may be configured for generating and displaying at least one of a calendar, a clock, a photo and weather information.

In further embodiments, the GUI engine 208 may be configured for displaying the at least one notification in each of the active mode and the idle mode.

Further, the calendar-based information management system 200 may include a user management engine 210 configured to manage a plurality of user profiles associated with the calendar-based information management system 200.

In some embodiments, the user management engine 210 may be further configured to authenticate at least one user of a plurality of users. Further, the processing of the at least one command may be based on successful authentication of the at least one user.

Further, the calendar-based information management system 200 may include a speech recognition engine 212 configured to perform speech recognition of a speech input and determine at least one command.

In further embodiments, the speech recognition engine 212 may be configured to identify a category of the plurality of categories and a description based on the speech input. Further, the at least one calendar event data may be based on each of identification of the category and the description.

Further, the calendar-based information management system 200 may include a command processing engine 214 configured to process the at least one command based on at least one of the speech input and the touch input.

Further, the calendar-based information management system 200 may include a storage device 216 configured to retrievably store a plurality of calendar event data and at least one digital data. Further, the storing may be based on the at least one command.

In further embodiments, the storage device 216 may be removably attached to the calendar-based information management system.

Further, the calendar-based information management system 200 may include a category management engine 218 configured to management a plurality of categories associated with the plurality of calendar event data.

In further embodiments, the category management engine 218 may be configured to customize the plurality of categories based on the plurality of user profiles.

Further, the calendar-based information management system 200 may include a notification engine 220 configured to generate at least one notification based on the plurality of calendar event data.

In further embodiments, the notification engine 220 may be configured to generate a notification a calendar event data. Further, the calendar event data may be associated with a user profile of the plurality of user profiles. Further, the communication device may be configured to transmit the notification to the external electronic device associated with the user profile based on a time associated with the calendar event data.

Further, the calendar-based information management system 200 may include a document and image repository engine 222 configured to process at least one digital document.

In further embodiments, the document and image repository engine 222 may be configured to generate a photo scrapbook based on a plurality of digital images.

In some embodiments, the communication device 206 may be configured to receive an external input from a first external electronic device associated with a first user profile of the plurality of user profiles. Further, the external input may include a modification to a calendar event data of the plurality of calendar event data. Further, the command processing engine 214 may be configured to generate an updated calendar event data based on the external input. Further, the communication device 206 may be configured to transmit the updated calendar event data to a second external electronic device associated with a second user profile of the plurality of user profiles.

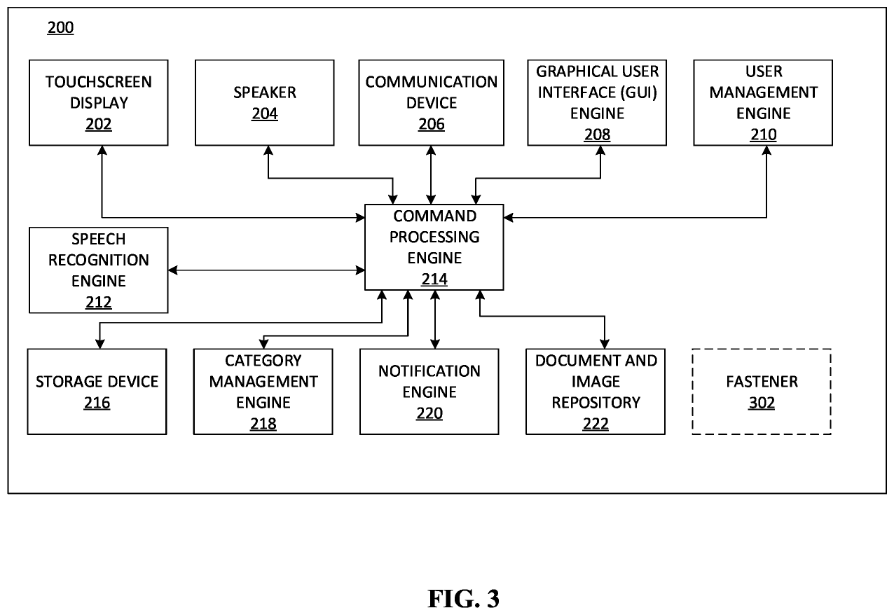

FIG. 3 is a block diagram of the calendar-based information management system 200, in accordance with some embodiments. As shown, the calendar-based information management system 200 may also include at least one fastener 302 configured to mount the calendar-based information system on a surface. For example, the surface may be a wall.

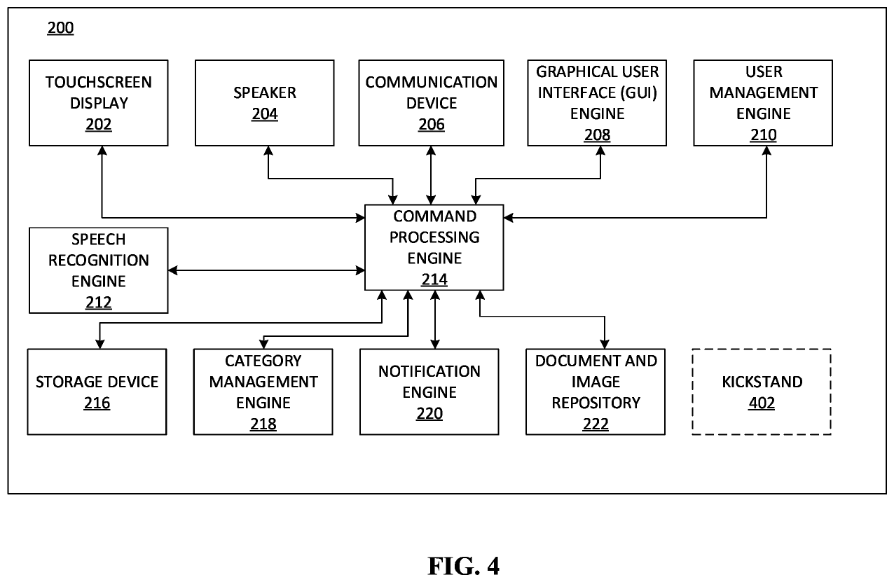

FIG. 4 is a block diagram of the calendar-based information management system 200, in accordance with some embodiments. As shown, the calendar-based information management system 200 may also include a kickstand 402 configured to maintain the calendar-based information management system in a standing position on a surface. For example, the surface may be a table.

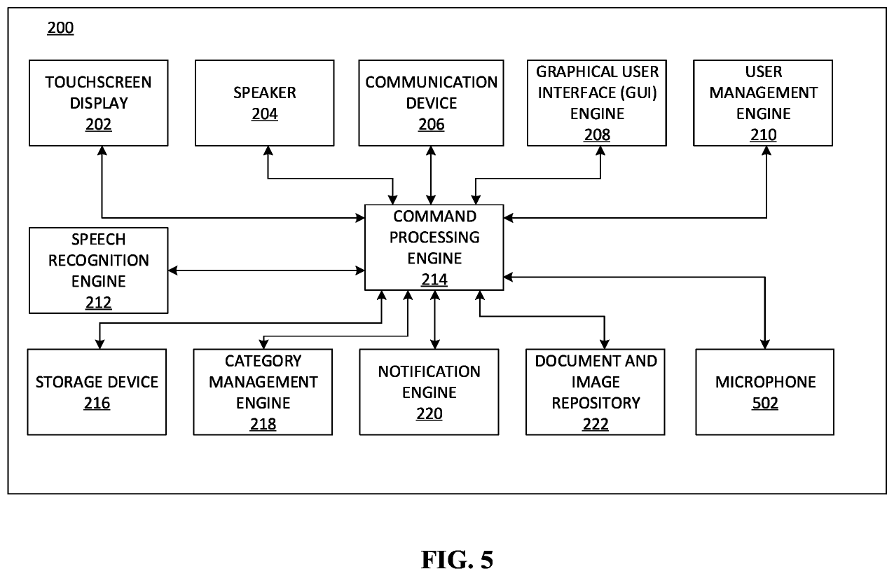

FIG. 5 is a block diagram of the calendar-based information management system 200, in accordance with some embodiments. As shown, the calendar-based information management system 200 may also include a microphone 502 configured to convert an acoustic input into a speech input.

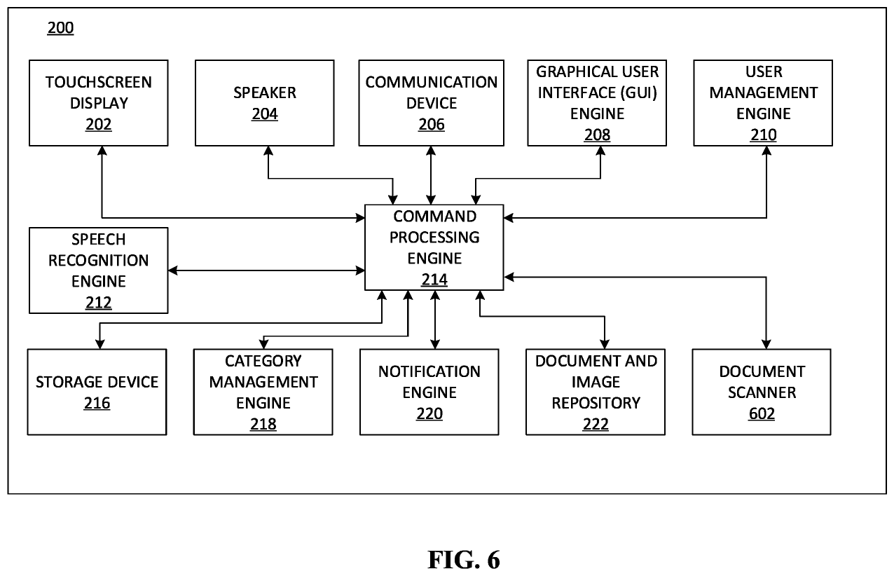

FIG. 6 is a block diagram of the calendar-based information management system 200, in accordance with some embodiments. As shown, the calendar-based information management system 200 may also include a document scanner 602 configured to generate a digital document corresponding to a physical document. Further, the document and image repository engine 222 may be configured to store the digital document.

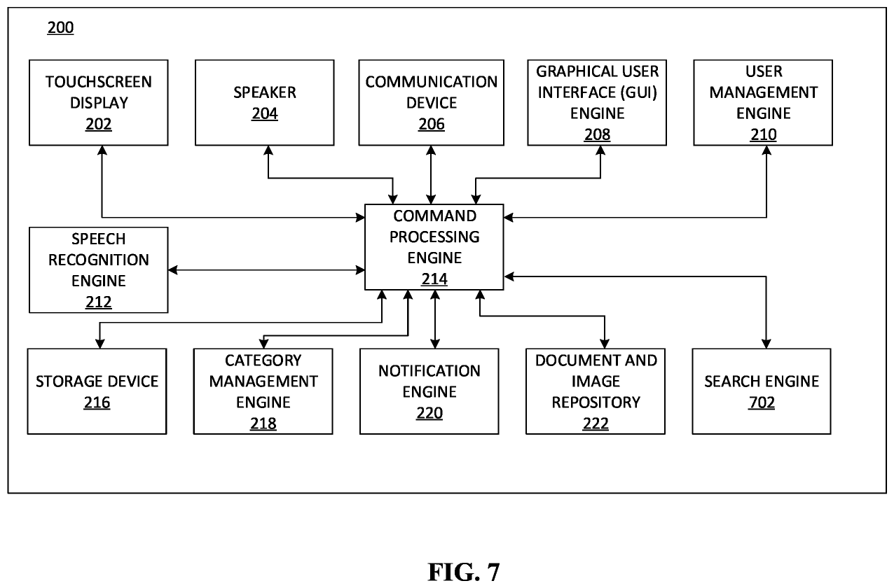

FIG. 7 is a block diagram of the calendar-based information management system 200, in accordance with some embodiments. As shown, the calendar-based information management system 200 may also include a search engine 702 configured to perform searching of the plurality of calendar event data based on a search query. Further, at least one of the touch input and the speech input may include the search query. Further, the search engine 702 may be configured to perform presenting at least one search result based on the searching. Further, the presenting may be performed on at least one of the touchscreen and the speaker.

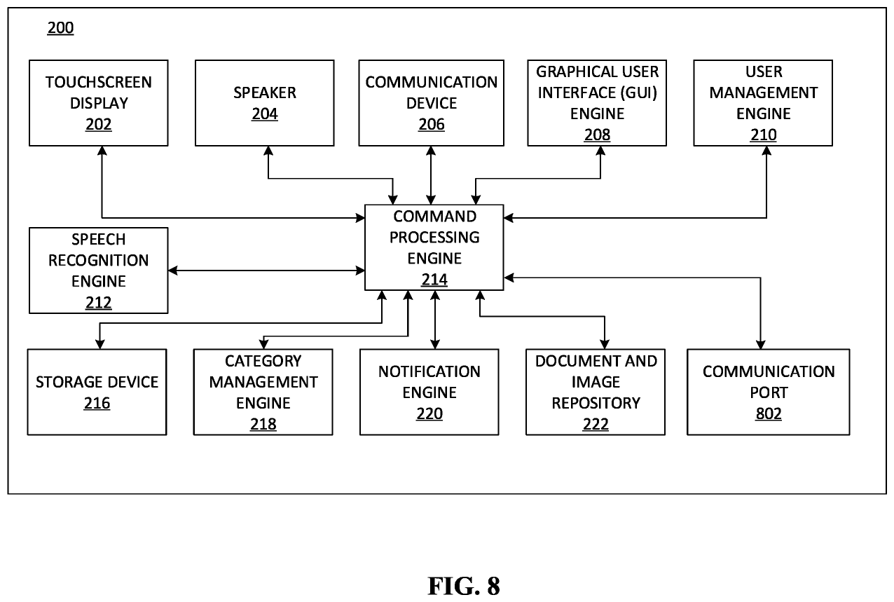

FIG. 8 is a block diagram of the calendar-based information management system 200, in accordance with some embodiments. As shown, the calendar-based information management system 200 may also include a communication port 802 configured to communicate with the external electronic device over a wired communication channel.

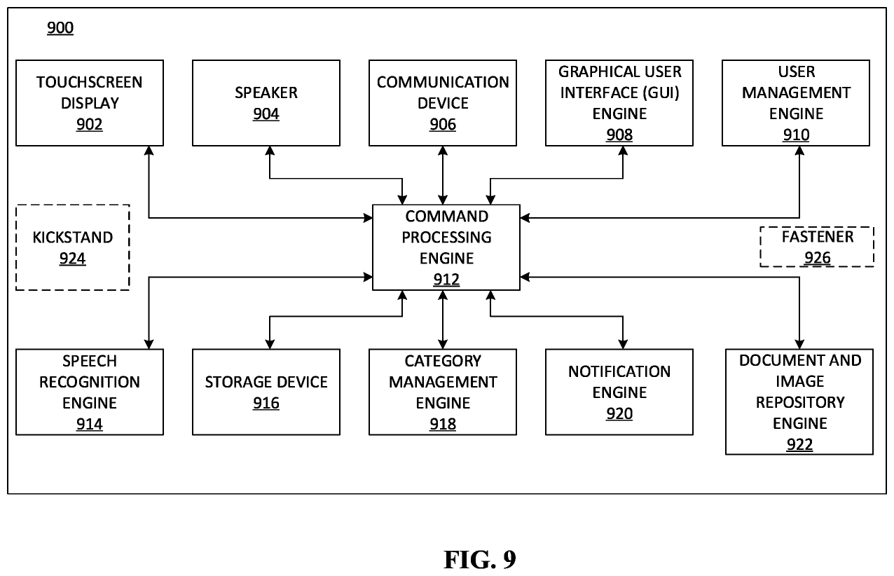

FIG. 9 is a block diagram of a calendar-based information management system 900, in accordance with some embodiments. The calendar-based information management system 900 may include a touchscreen display 902 configured for displaying digital content and receiving a touch input corresponding to the digital content.

Further, the calendar-based information management system 900 may include a speaker 904 configured to produce an audible output.

Further, the calendar-based information management system 900 may include a communication device 906 configured to communicate with an external electronic device over a wireless communication channel.

Further, the calendar-based information management system 900 may include a graphical user interface (GUI) engine 908 configured for generating the GUI presented through the touchscreen.

Further, the calendar-based information management system 900 may include a user management engine 910 configured to manage a plurality of user profiles associated with the calendar-based information management system 900.

Further, the calendar-based information management system 900 may include a speech recognition engine 914 configured to perform speech recognition of a speech input and determine at least one command.

Further, the calendar-based information management system 900 may include a command processing engine 912 configured to process the at least one command based on at least one of the speech input and the touch input.

Further, the calendar-based information management system 900 may include a storage device 916 configured to retrievably store a plurality of calendar event data and at least one digital data. Further, the storing may be based on the at least one command.

Further, the calendar-based information management system 900 may include a category management engine 918 configured to management a plurality of categories associated with the plurality of calendar event data.

Further, the calendar-based information management system 900 may include a notification engine 920 configured to generate at least one notification based on the plurality of calendar event data.

Further, the calendar-based information management system 900 may include a document and image repository engine 922 configured to process at least one digital document.

Further, the calendar-based information management system 900 may include a kickstand 924 configured to maintain the calendar-based information management system 900 in a standing position on a horizontal surface.

Further, the calendar-based information management system 900 may include at least one fastener 926 configured to mount the calendar-based information system on a wall.

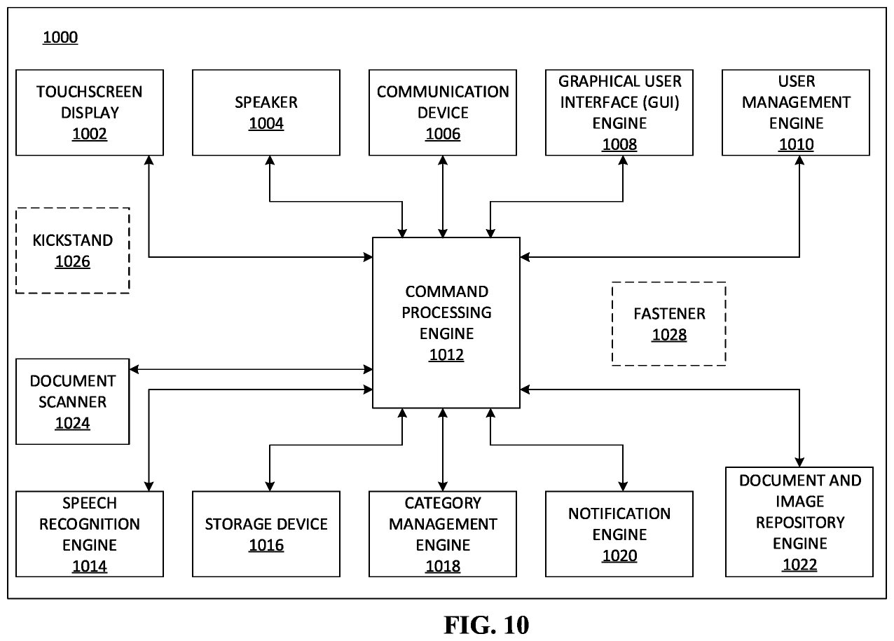

FIG. 10 is a block diagram of a calendar-based information management system 1000, in accordance with some embodiments. The calendar-based information management system 1000 may include a touchscreen display 1002 configured for displaying digital content and receiving a touch input corresponding to the digital content.

Further, the calendar-based information management system 1000 may include a speaker 1004 configured to produce an audible output.

Further, the calendar-based information management system 1000 may include a communication device 1006 configured to communicate with an external electronic device over a wireless communication channel.

Further, the calendar-based information management system 1000 may include a graphical user interface (GUI) engine 1008 configured for generating the GUI presented through the touchscreen.

Further, the calendar-based information management system 1000 may include a user management engine 1010 configured to manage a plurality of user profiles associated with the calendar-based information management system 1000.

Further, the calendar-based information management system 1000 may include a speech recognition engine 1014 configured to perform speech recognition of a speech input and determine at least one command.

Further, the calendar-based information management system 1000 may include a command processing engine 1012 configured to process the at least one command based on at least one of the speech input and the touch input.

Further, the calendar-based information management system 1000 may include a storage device 1016 configured to retrievably store a plurality of calendar event data and at least one digital data. Further, the storing may be based on the at least one command.

Further, the calendar-based information management system 1000 may include a category management engine 1018 configured to management a plurality of categories associated with the plurality of calendar event data.

Further, the calendar-based information management system 1000 may include a notification engine 1020 configured to generate at least one notification based on the plurality of calendar event data.

Further, the calendar-based information management system 1000 may include a document and image repository engine 1022 configured to process at least one digital document.

Further, the calendar-based information management system 1000 may include a document scanner 1024 configured to generate a digital document corresponding to a physical document. Further, the document and image repository engine 1022 may be configured to store the digital document.

Further, the calendar-based information management system 1000 may include a kickstand 1026 configured to maintain the calendar-based information management system 1000 in a standing position on a horizontal surface.

Further, the calendar-based information management system 1000 may include at least one fastener 1028 configured to mount the calendar-based information system on a wall.

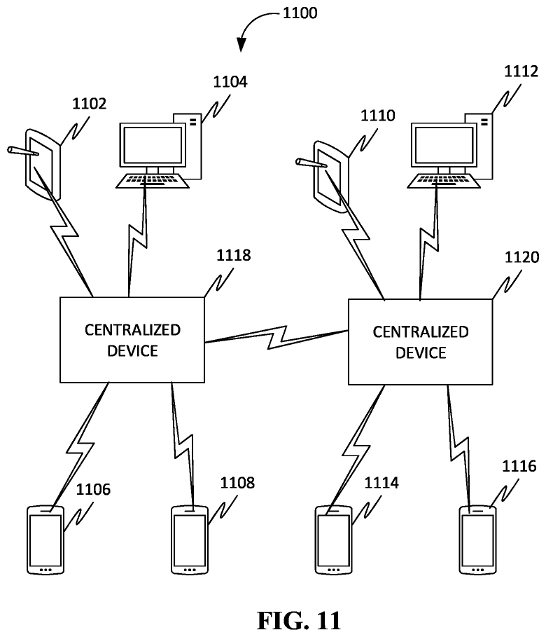

FIG. 11 is an illustration of architecture 1100 for implementing the present disclosure, in accordance with some embodiments.

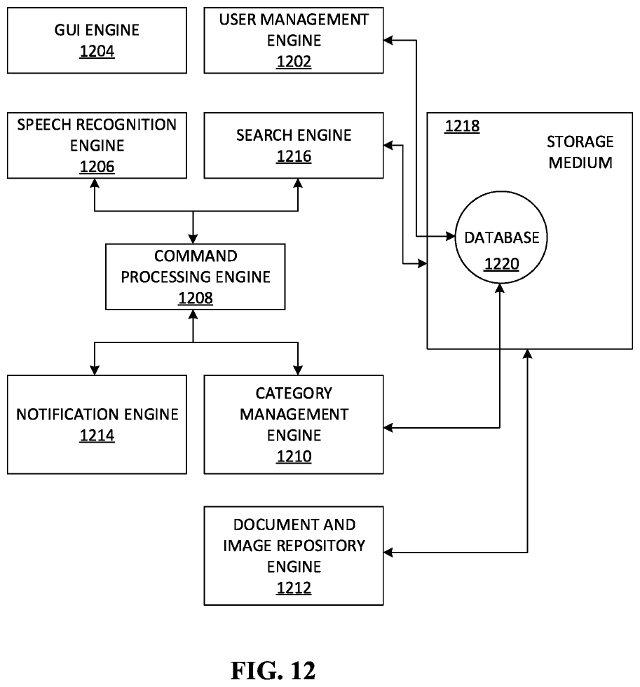

The present disclosure is related to a calendar-based information management system which is a system for managing information for a group of users based on the calendar. As shown in FIG. 12, the calendar-based information management system may include a user management engine 1202, a graphical user interface (“GUI”) engine 1204, a speech recognition engine 1206, a command processing engine 1208, a category management engine 1210, a document and image repository engine 1212, a notification engine 1214, a search engine 1216 and a database 1220.

Further, the disclosed calendar-based information management system allows a group of users (with user devices 1102-1116) to manage their personal or business-related information on a centralized device (such as centralized devices 1118-1120), categorize the information for easy access, and retrieve the information more efficiently.

Further, the disclosed calendar-based information management system may be operated on a digital calendar which possesses computing capability and network connectivity.

Moreover, the disclosed calendar-based information management system may allow the users in the group to remotely manage (e.g., create, store, retrieve, manipulate, organize, present, etc.) the information, back up important documents and images, and ensure privacy and confidentiality.

Further, the disclosed calendar-based information management system may be accessed from a centralized device, or from user terminals which communicates with the centralized device via the network. An application which is designed to control the calendar-based information management system may also be provided on the user terminals.

As used herein, the term “engine” is used herein to refer to collections of programs which are grouped based upon function. The term “centralized device” is used herein to refer to a variety of devices that are capable of running the present disclosure. Preferably, the centralized device comprises a touchscreen display, a microphone, a speaker and/or other components as necessary. As an example, the centralized device could be a digital calendar hanging on the wall. The term “user terminal” is used herein to refer to any digital devices that are capable of communicating with the centralized device via any suitable communication protocol, including but not limited to radio communication protocols and/or communication protocols used in a data network. For example, the user terminals may be laptops, desktops, workstation, or handheld devices such as smartphones, tablets, etc. The term “calendar event” is used herein to refer to any recorded events associated with the calendar, including but not limited to appointments, to-do lists, bills that are due, etc. The term “command” is used to refer to users' instructions that are input into the centralized device and indicate what to do with the present disclosure.

In some embodiments, the user management engine 1202 may be used to register users in the system and perform authentication of the users. The user management engine 1202 receives each user's profile information and creates a user profile. For example, the user's profile information may include but not limited to name, phone number, password, user's relationship to each other, and/or voice recognition information. In one embodiment, the user management engine 1202 generates login credentials for the user based on the user's profile information and stores the login credentials in the database 1220. In this way, each user is able to remotely access the calendar-based information management system using the login credentials from their smartphones, laptops, desktops, etc. With the aid of the user management engine 1202, the present disclosure allows different users to store their calendar events in the centralized device by associating the calendar events with the users. Each calendar event may contain profile information of the user creating that event.

The GUI engine 1204 generates graphical data for displaying a user interface which enables the users to interact with the system. The users may input information into the user interface and the GUI engine 1204 relays the information to other engines for further processing. For example, the user interface may include a login box into which the users may enter login credentials, and then the credentials are transmitted from the user interface engine to the user management engine 1202 for user authentication. If the login credentials do not match with those in the database 1220, the GUI engine 1204 may generate a pop-up window requiring the user to re-enter the credentials. Further, when the system is idle, the GUI engine 1204 may generate graphical data on the centralized device for displaying a calendar, a clock, photos and/or weather forecast such that the users may readily obtain the date, time and/or weather information without accessing the centralized device.

The speech recognition engine 1206 is capable of processing input audio speech information, recognize what was spoken, and convert the spoken language into machine-readable commands. The audio speech information may be gathered from a microphone integrated into the centralized device or transferred directly from the user terminals. For example, a smartphone user may input audio speech via the microphone of the smartphone, and then transmit the audio speech to the speech recognition engine 1206 via the app installed on the smartphone. Then the speech recognition engine 1206 converts the audio speech into a command. The command is then passed to the command processing engine 1208 which will be described in more detail hereinafter.

The command processing engine 1208 receives commands and instructs a corresponding engine to perform various functions as commanded. As stated above, the commands may be generated by and transmitted from the speech recognition engine 1206; however, the commands may also be generated by touching the graphical user interface generated by the GUI engine 1204, or directly received from the user terminals of the users. Once the commands are received, the command processing engine 1208 reads these commands and accordingly instructs other engines to execute the commands. The category management engine 1210 allows users to manage customized categories and store entries under the categories. In one embodiment, family members may create daily life related categories, including but not limited to mortgage, grocery, emergency information, doctor appointments, bills, schedules, birthdays, medications, photos, documents, etc. In another embodiment, the members of a business organization may create business-related categories, such as employee contact information, staff receipts, inventory, etc. As an example, the user may touch a day on the calendar and enter an appointment event information into a pop-up dialog box generated by the GUI engine 1204 and select the category “appointments”. Then the appointment event may be saved under the category “appointments”. As another example, a user may access the centralized device and say “add apple to grocery”. The speech recognition engine 1206 translates the spoken phrase into a command for adding “apple” under the category “grocery”. The command is sent to the command processing engine 1208, which then instructs the category management engine 1210 to generate an entry “apple” under the category “grocery”.

The document and image repository engine 1212 is used to store received documents and images in a storage medium 1218. Further, the documents and images may be scanned from a scanner which is built in the centralized device. Moreover, the documents and images can be received from user terminals via a wireless network, or directly uploaded from a universal serial bus (USB) port. The storage medium 1218 may be arranged in the centralized device. However, the storage medium 1218 may also be a removable storage device, minimizing the risk of private documents and images being exposed on the internet. The document and image repository engine 1212 is also able to send the stored documents and images to external devices or user terminals via the wireless or wired network. For example, the document and image repository engine 1212 may send a photo to an external printer to print the photo out or to a user's smartphone via email. As illustrated in FIG. 11, the document and image repository engine 1212 also allows the stored documents and images to be shared with other centralized devices. In one embodiment, the document and image repository engine 1212 is able to generate photo scrapbook using the stored images.

The search engine 1216 is configured to identify any information related to a search query. In one embodiment, a search text box may be provided in the graphical user interface generated by the GUI engine 1204. To conduct a search, the user may enter the desired search query into the search text box and initiate the searching process by, for example, clicking the “search” button in the search text box. The search engine 1216 receives the search query and then access the database 1212 and/or storage medium 121 for identifying calendar events, documents, images and/or any other information containing all the keywords in the search query. For examples, if the user provides the term “Jake's doctor appointments” as the search query, the search engine 1216 may identify calendar events that comprise the keywords “doctor”, “Jake” and “appointments”. The search engine 1216 also enables the users to retrieve information relevant to a particular category or date. In another embodiment, the search is performed using a voice command. For example, the user may say “show me the grocery list”, and the speech recognition engine 1206 translates the spoken phrase into a search command which is sent to the command processing engine 1208. The command processing engine 1208 then instructs the search engine 1216 to pull up all the entries under the category “grocery”.

In one embodiment, the notification engine 1214 is configured to access the calendar events and generates notifications indicating the occurrence of the calendar events. For example, the notification engine 1214 is able to read the calendar events under the category “appointments” and generate notifications indicating the time of the appointments. The notification may be sent to the user terminals at or before the time of the appointments to remind the associated users of the appointments. In another embodiment, the notification is generated by one user and is sent to another user. As an example, the mom in a family may say “send a message to my son Jake” to the centralized device and then say the content of the message. The speech recognition engine 1206 translates the spoken message into text which is sent to the command processing engine 1208. The command processing engine 1208 then instructs the notification engine 1214 to send the content of the message to her son, Jake. Further, the notifications may comprise visual, audio and/or tactile alerts.

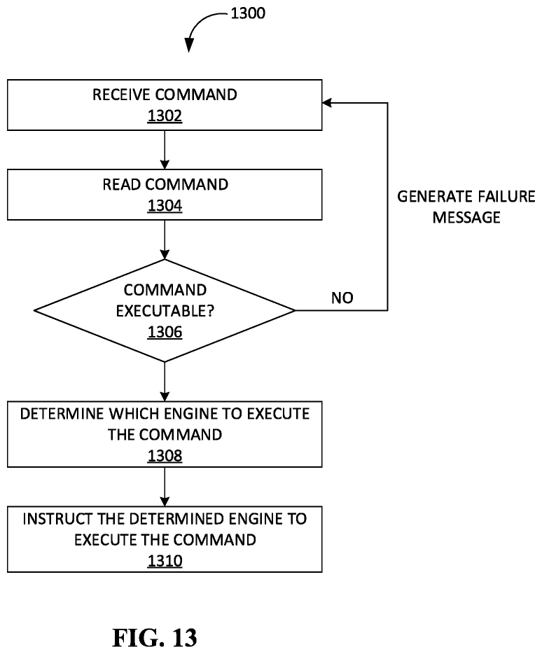

FIG. 13 is a flowchart of a method 1300 to process the commands, in accordance with some embodiments. At 1302, the method 1300 may include receiving a command. Then, at 1304, the method 1300 may include reading the command. Then, at 1306, the method 1300 may include checking if the command is executable. At 1306, if it is determined that the command is executable, then the method 1300 goes to 1308. At 1308, the method 1300 may include determining the engine to execute the command. At 1310, the method 1300 may include instructing the determined engine to execute the command. However, at 1306, if it is determined that the command is not executable, then the method 1300 goes to 1302.

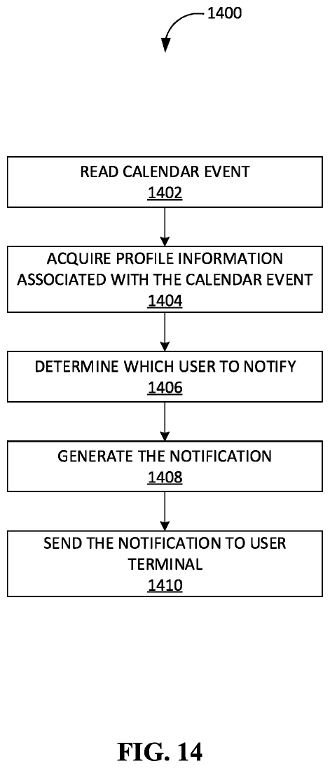

FIG. 14 is a flowchart of a method 1400 to generate notifications, in accordance with some embodiments. At 1402, the method 1400 may include reading calender event. Then, at 1404, the method 1400 may include acquiring profile information associated with the calendar event. Then, at 1406, the method 1400 may include determining which user to notify. Then, at 1408, the method 1400 may include generating the notification. Then, at 1410, the method 1400 may include sending the notification to user terminal.

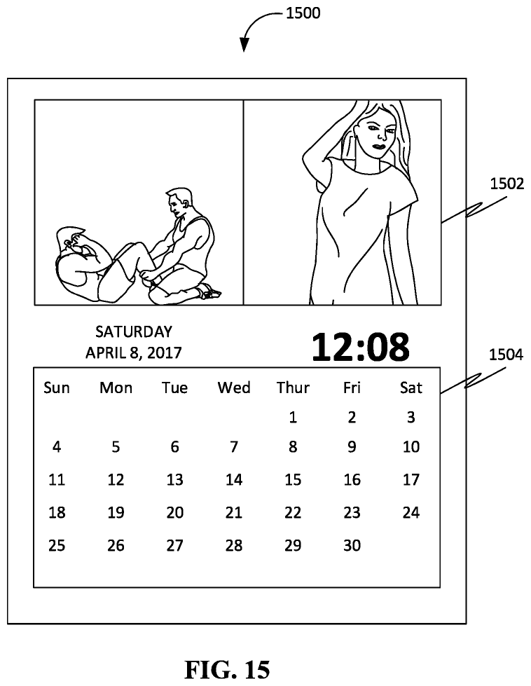

FIG. 15 is a digital wall mountable device 1500, in accordance with some embodiments. The digital wall mountable device 1500 may be driven via an application (such as MyTekc application) to run, manage, store and organize everything in life that is important. The digital wall mountable device 1500 may be used like a paper wall calendar and organizer but with a touch or a voice command. Owners of the digital wall mountable device 1500 may store, manage and easily retrieve everything as simple as touching the grocery category and saying pepper. Further, the digital wall mountable device 1500 may allow for filing and storing documents in one device with the touch of a finger or spoken commands. Further, the owners of the digital wall mountable device 1500 may utilize the downloadable application on their family's phones to give them a remote control that may give them access to the digital wall mountable device 1500 from anywhere. So, whatever they need today from wherever they are is safely stored, and it is just one touch away.

Further, the digital wall mountable device 1500 may hang on the wall by a simple hanging apparatus or may easily stand (by stand up apparatus) on a desk in a central location of a home or office appearing as a unique electronic wall calendar and clock, displaying the owner's digital photos over the top of the calendar. Further, digital wall mountable device 1500 may include a digital photo displayer 1502 to show photos along with a calender displayer 1504. Therefore, a family may enjoy photos with auto rotation singly or along with the calendar. Further, the digital wall mountable device 1500 may allow owners to create awesome digital scrapbooks for fantastic trips down memory lane that may be passed down to future generations.

According to some embodiments, the digital wall mountable device 1500 may have a size of 10 cm×11 cm. The owners may touch the digital wall mountable device 1500 to talk on command. Further, the owns may touch the day, or the category and say “doctor apt 2:30”. Further, the digital wall mountable device 1500 may provide direct access to grandparents for sharing photos or special events etc. Further, the digital wall mountable device 1500 may include a USB port for quickly backing up photos and contact information on phones.

Further, the application may be downloaded on a phone (s) to access, add or retrieve any list or information, or document from any location when required. When using the phone application, everything automatically backs up to the digital wall mountable device 1500.

Further, the touch of a finger on the digital wall mountable device 1500 may provides Tally's and totals of any category such as house payments, bills and medications, family birthday's etc.

Further, the owner of the digital wall mountable device 1500 or application may choose and set their own category's. For example, the owner may take a photo of any document and chose a category and file. i.e. birth, marriage, death certificates, school records, medical forms etc.

Further, the owner may connect the application to wireless printer.

Further, the digital wall mountable device 1500 ensures that people never lose information.

Further, the main purpose of the digital wall mountable device 1500 is receiving and securely housing multiple categories of data in a simple filing system through the calendar and category display.

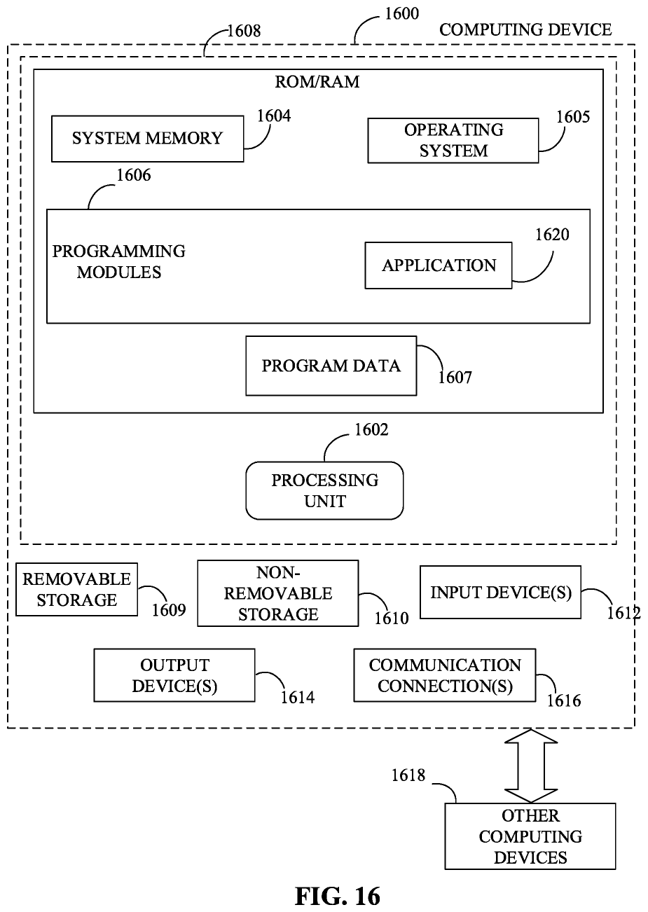

With reference to FIG. 16, a system consistent with an embodiment of the disclosure may include a computing device or cloud service, such as computing device 1600. In a basic configuration, computing device 1600 may include at least one processing unit 1602 and a system memory 1604. Depending on the configuration and type of computing device, system memory 1604 may comprise, but is not limited to, volatile (e.g. random-access memory (RAM)), non-volatile (e.g. read-only memory (ROM)), flash memory, or any combination. System memory 1604 may include operating system 1605, one or more programming modules 1606, and may include a program data 1607. Operating system 1605, for example, may be suitable for controlling computing device 1600's operation. In one embodiment, programming modules 1606 may include image-processing module, machine learning module. Furthermore, embodiments of the disclosure may be practiced in conjunction with a graphics library, other operating systems, or any other application program and is not limited to any particular application or system. This basic configuration is illustrated in FIG. 16 by those components within a dashed line 1608.

Computing device 1600 may have additional features or functionality. For example, computing device 1600 may also include additional data storage devices (removable and/or non-removable) such as, for example, magnetic disks, optical disks, or tape. Such additional storage is illustrated in FIG. 16 by a removable storage 1609 and a non-removable storage 1610. Computer storage media may include volatile and non-volatile, removable and non-removable media implemented in any method or technology for storage of information, such as computer-readable instructions, data structures, program modules, or other data. System memory 1604, removable storage 1609, and non-removable storage 1610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which may be used to store information and which may be accessed by computing device 1600. Any such computer storage media may be part of device 1600. Computing device 1600 may also have input device(s) 1612 such as a keyboard, a mouse, a pen, a sound input device, a touch input device, a location sensor, a camera, a biometric sensor, etc. Output device(s) 1614 such as a display, speakers, a printer, etc. may also be included. The aforementioned devices are examples and others may be used.

Computing device 1600 may also contain a communication connection 1616 that may allow device 1600 to communicate with other computing devices 1618, such as over a network in a distributed computing environment, for example, an intranet or the Internet. Communication connection 1616 is one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory 1604, including operating system 1605. While executing on processing unit 1602, programming modules 1606 (e.g., application 1620 such as a media player) may perform processes including, for example, one or more stages of methods, algorithms, systems, applications, servers, databases as described above. The aforementioned process is an example, and processing unit 1602 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that may contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program may be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data may also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention as hereinafter claimed.

What is claimed is:

1. A calendar-based information management system comprising:
a touchscreen display configured for displaying digital content and receiving a touch input corresponding to the digital content;
a speaker configured to produce an audible output;
a communication device configured to communicate with an external electronic device over a wireless communication channel;
a graphical user interface (GUI) engine configured for generating the GUI presented through the touchscreen;
a user management engine configured to manage a plurality of user profiles associated with the calendar-based information management system;
a speech recognition engine configured to perform speech recognition of a speech input and determine at least one command;
a command processing engine configured to process the at least one command based on at least one of the speech input and the touch input;
a storage device configured to retrievably store a plurality of calendar event data and at least one digital data, wherein the storing is based on the at least one command;
a category management engine configured to management a plurality of categories associated with the plurality of calendar event data;
a notification engine configured to generate at least one notification based on the plurality of calendar event data; and
a document and image repository engine configured to process at least one digital document.

2. The calendar-based information management system of claim 1 further comprising at least one fastener configured to mount the calendar-based information system on a surface.

3. The calendar-based information management system of claim 1 further comprising a kickstand configured to maintain the calendar-based information management system in a standing position on a surface.

4. The calendar-based information management system of claim 1, wherein the user management engine is further configured to authenticate at least one user of a plurality of users, wherein the processing of the at least one command is based on successful authentication of the at least one user.

5. The calendar-based information management system of claim 1, wherein the GUI engine is associated with an active mode and an idle mode, wherein in the idle mode, the GUI engine is configured for generating and displaying at least one of a calendar, a clock, a photo and weather information.

6. The calendar-based information management system of claim 5, wherein the GUI engine is configured for displaying the at least one notification in each of the active mode and the idle mode.

7. The calendar-based information management system of claim 1 further comprising a microphone configured to convert an acoustic input into a speech input.

8. The calendar-based information management system of claim 1, wherein the communication device is configured to receive the speech input from the external electronic device, wherein the external electronic device comprises a microphone configured to convert an acoustic input into a speech input.

9. The calendar-based information management system of claim 1, wherein the touch input comprises a first touch input and a second touch input, wherein the first touch input is associated with a day of a calendar displayed on the touchscreen, wherein the second touch input is associated with a category of the plurality of categories, wherein the speech input comprises a description, wherein the at least one calendar event data is based on each of the first input, the second input and the description.

10. The calendar-based information management system of claim 1 wherein the speech recognition engine configured to identify a category of the plurality of categories and a description based on the speech input, wherein the at least one calendar event data is based on each of identification of the category and the description.

11. The calendar-based information management system of claim 1, wherein the category management engine is configured to customize the plurality of categories based on the plurality of user profiles.

12. The calendar-based information management system of claim 1 comprising a document scanner configured to generate a digital document corresponding to a physical document, wherein the document and image repository engine is configured to store the digital document.

13. The calendar-based information management system of claim 1, wherein the document and image repository engine is configured to generate a photo scrapbook based on a plurality of digital images.

14. The calendar-based information management system of claim 1 further comprising a search engine configured to perform:
searching of the plurality of calendar event data based on a search query, wherein at least one of the touch input and the speech input comprises the search query; and
presenting at least one search result based on the searching, wherein the presenting is performed on at least one of the touchscreen and the speaker.

15. The calendar-based information management system of claim 1, wherein notification engine is configured to generate a notification a calendar event data, wherein the calendar event data is associated with a user profile of the plurality of user profiles, wherein the communication device is further configured to transmit the notification to the external electronic device associated with the user profile based on a time associated with the calendar event data.

16. The calendar-based information management system of claim 1, wherein the communication device is configured to receive an external input from a first external electronic device associated with a first user profile of the plurality of user profiles, wherein the external input comprises a modification to a calendar event data of the plurality of calendar event data, wherein the command processing engine is configured to generate an updated calendar event data based on the external input, wherein the communication device is further configured to transmit the updated calendar event data to a second external electronic device associated with a second user profile of the plurality of user profiles.

17. The calendar-based information management system of claim 1 further comprising a communication port configured to communicate with the external electronic device over a wired communication channel.

18. The calendar-based information management system of claim 1, wherein the storage device is removably attached to the calendar-based information management system.

19. A calendar-based information management system comprising:
a touchscreen display configured for displaying digital content and receiving a touch input corresponding to the digital content;
a speaker configured to produce an audible output;
a communication device configured to communicate with an external electronic device over a wireless communication channel;
a graphical user interface (GUI) engine configured for generating the GUI presented through the touchscreen;
a user management engine configured to manage a plurality of user profiles associated with the calendar-based information management system;
a speech recognition engine configured to perform speech recognition of a speech input and determine at least one command;
a command processing engine configured to process the at least one command based on at least one of the speech input and the touch input;
a storage device configured to retrievably store a plurality of calendar event data and at least one digital data, wherein the storing is based on the at least one command;
a category management engine configured to management a plurality of categories associated with the plurality of calendar event data;
a notification engine configured to generate at least one notification based on the plurality of calendar event data;
a document and image repository engine configured to process at least one digital document;
at least one fastener configured to mount the calendar-based information system on a wall; and
a kickstand configured to maintain the calendar-based information management system in a standing position on a horizontal surface.

20. A calendar-based information management system comprising:
a touchscreen display configured for displaying digital content and receiving a touch input corresponding to the digital content;
a speaker configured to produce an audible output;
a communication device configured to communicate with an external electronic device over a wireless communication channel;
a graphical user interface (GUI) engine configured for generating the GUI presented through the touchscreen;
a user management engine configured to manage a plurality of user profiles associated with the calendar-based information management system;
a speech recognition engine configured to perform speech recognition of a speech input and determine at least one command;
a command processing engine configured to process the at least one command based on at least one of the speech input and the touch input;
a storage device configured to retrievably store a plurality of calendar event data and at least one digital data, wherein the storing is based on the at least one command;
a category management engine configured to management a plurality of categories associated with the plurality of calendar event data;
a notification engine configured to generate at least one notification based on the plurality of calendar event data;
a document and image repository engine configured to process at least one digital document;
at least one fastener configured to mount the calendar-based information system on a wall;
a kickstand configured to maintain the calendar-based information management system in a standing position on a horizontal surface; and
a document scanner configured to generate a digital document corresponding to a physical document, wherein the document and image repository engine is configured to store the digital document.
